(19) United States
(12) Patent Application Publication
(10) Pub. No.: US 2026/0008491 A1
(43) Pub. Date: Jan. 8, 2026

(54) STEERING ASSEMBLY FOR VEHICLES

(71) Applicant: BOMBARDIER RECREATIONAL PRODUCTS INC., Valcourt (CA)

(72) Inventors: Jean-Sebastien PARD, Tingwick (CA); Maxime TURGEON, Shefford (CA); Maxime JOLICOEUR, Racine (CA); Guillaume AUGER, Danville (CA); Alexandre THIBAULT, Sherbrooke (CA); Danae GRISE, Ange-Gardien (CA)

(21) Appl. No.: 19/259,817

(22) Filed: Jul. 3, 2025

Related U.S. Application Data
(60) Provisional application No. 63/667,744, filed on Jul. 4, 2024.

(51) Int. Cl. B62D 1/183; B62D 1/184

(52) U.S. Cl. CPC B62D 1/183; B62D 1/184; B60Y 2200/20

(57) ABSTRACT

A steering assembly of a vehicle and the vehicle thereof are disclosed. The steering assembly includes: a steering input device configured to steer the vehicle and to pivotably connect to a frame of the vehicle to pivot about a laterally extending pivot axis. The steering assembly includes an adjustment assembly and a coupling assembly, where one of the adjustment assembly and the coupling assembly is disposed between the steering input device and an other one of the adjustment assembly and the coupling assembly. The adjustment assembly is configured to select a driving position of the steering input device. The coupling assembly has a coupled configuration, in which, upon actuation of the adjustment assembly, the steering input device is moveable about the pivot axis, and an uncoupled configuration, in which, without actuation of the adjustment assembly, the steering input device is moveable about the pivot axis to an ingress-egress position.

### CROSS-REFERENCE

The present application claims priority to the U.S. Provisional Patent Application No. 63/667,744, filed Jul. 4, 2024, entitled “STEERING ASSEMBLY FOR VEHICLES”, which is incorporated by reference herein in its entirety.

### FIELD OF TECHNOLOGY

The present technology relates to vehicles having a steering assembly.

### BACKGROUND

Off-road vehicles, such as side-by-side vehicles (SSVs), have limited space available for entering and exiting the vehicle. The presence of the steering wheel obstructs a driver's path, making it difficult to get in and out of the vehicle comfortably.

While current adjustment systems allow the steering wheel to be tilted and/or telescoped to accommodate driving preferences of the driver, the range of motion provided by these systems is often insufficient to facilitate easier driver ingress and egress. Additionally, each time the driver adjusts the steering wheel for easier entry or exit, the adjustment system requires manual re-adjustment to restore the driver's preferred driving settings, resulting in a repetitive, inefficient, and time-consuming process.

There is thus a desire for a vehicle having a steering assembly that addresses at least in part some of these drawbacks.

### SUMMARY

It is an object of the present technology to ameliorate at least some of the inconveniences present in the prior art.

According to aspects of the present technology, there is provided a steering assembly for steering a vehicle. The steering assembly includes: a steering input device configured to steer the vehicle and to pivotably connect to a frame of the vehicle to pivot about a laterally extending pivot axis, an adjustment assembly configured to select a driving position of the steering input device from a plurality of driving positions; a coupling assembly having: a coupled configuration, in which, upon actuation of the adjustment assembly, the steering input device is moveable about the pivot axis between the plurality of driving positions; and an uncoupled configuration, in which, without actuation of the adjustment assembly, the steering input device is moveable about the pivot axis to an ingress-egress position; and one of the adjustment assembly and the coupling assembly being disposed between the steering input device and an other one of the adjustment assembly and the coupling assembly.

In some embodiments, the coupling assembly is disposed between the steering input device and the adjustment assembly.

In some embodiments, the steering assembly further includes a dashboard frame portion connected to the adjustment assembly and adapted to connect to the frame of the vehicle; and wherein the steering input device is pivotably connected to the dashboard frame portion.

In some embodiments, in the uncoupled configuration, the adjustment assembly is uncoupled from the steering input device such that the steering input device is movable independently from the adjustment assembly.

In some embodiments, in the coupled configuration, the adjustment assembly is connected to the steering input device.

In some embodiments, the adjustment assembly defines an aperture; and the coupling assembly is connected to the steering input device, the coupling assembly includes: an actuator; and a pin operatively connected to the actuator, the pin being moveable between: an extended position, in which the pin is slidably received in the aperture, thereby coupling the steering input device and the adjustment assembly in the coupled configuration, and a retracted position, in which the steering input device and the adjustment assembly are in the uncoupled configuration.

In some embodiments, the pin includes a rounded tip which is slidably receivable in the aperture.

In some embodiments, the pin is spring-loaded to bias the pin towards the extended position.

In some embodiments, upon actuation of the actuator, the pin moves from the extended position to the retracted position.

In some embodiments, the pin moves in a direction parallel to the pivot axis.

In some embodiments, the actuator includes a lever.

In some embodiments, the adjustment assembly includes a locking mechanism configured to selectively lock a state of the adjustment assembly, thereby locking the selected driving position of the steering input device.

In some embodiments, in the uncoupled configuration, the locking assembly retains the state of the adjustment assembly.

In some embodiments, the adjustment assembly is disposed below the steering input device.

In some embodiments, the steering assembly further includes at least one biasing member configured to bias the steering input device upwards when the steering input device and the adjustment assembly are in the uncoupled configuration.

In some embodiments, the at least one biasing member is a spring disposed about the pivot axis, the spring having: a first end connected to the steering input device, and a second end configured to connect to the frame of the vehicle.

In some embodiments, in the coupled configuration, the steering input device is pivotable within a coupled range of motion; and in the uncoupled configuration, the steering input device is pivotable within an uncoupled range of motion, the uncoupled range of motion being larger than the coupled range of motion.

According to aspects of the present technology there is provided a vehicle. The vehicle including: a frame; a plurality of ground-engaging members operatively connected to the frame; a motor supported by the frame for driving the vehicle; and a steering assembly having: a steering input device for steering the vehicle, the steering input device pivotably connected to the frame to pivot about a laterally extending pivot axis; an adjustment assembly configured to select a driving position of the steering input device from a plurality of driving positions; a coupling assembly having: a coupled configuration, in which, upon actuation of the adjustment assembly, the steering input device is moveable about the pivot axis between the plurality of driving positions; and an uncoupled configuration, in which, without actuation of the adjustment assembly, the steering input device is moveable about the pivot axis to an ingress-egress position; and one of the adjustment assembly and the coupling assembly being disposed between the steering input device and an other one of the adjustment assembly and the coupling assembly.

In some embodiments, the coupled assembly is disposed in between the steering input device and the adjustment assembly.

In some embodiments, in the uncoupled configuration, the adjustment assembly is uncoupled from the steering input device such that the steering input device is movable independently from the adjustment assembly.

In some embodiments, the vehicle further includes a dashboard; the steering assembly includes a dashboard frame portion forming at least part of the dashboard; and the steering input device is pivotably connected to the dashboard frame portion.

In some embodiments, the vehicle further includes at least one biasing member for biasing the steering input device away from the adjustment assembly and towards the dashboard when the coupling assembly is in the uncoupled configuration.

In some embodiments, in the coupled configuration the adjustment assembly is connected to the steering input device.

In some embodiments, the vehicle is a side-by-side vehicle.

According to aspects of the present technology there is provided a method for adjusting a position of a steering input device of a vehicle. The method includes: adjusting a position of the steering input device between multiple driving positions using an adjustment assembly by pivoting the steering input device about a laterally extending pivot axis; uncoupling the steering input device from the adjustment assembly; and with the steering input device uncoupled from the adjustment assembly, pivoting the steering input device up and away from the adjustment assembly to an ingress-egress position.

In some embodiments, uncoupling the steering input device from the adjustment assembly includes actuating an actuator of a coupling assembly of the vehicle to retract a pin of the coupling assembly from an aperture defined by the adjustment assembly of the vehicle.

In some embodiments, the method further includes pivoting the steering input device from the ingress-egress position down and towards the adjustment assembly to the selected driving position.

In some embodiments, the method further includes coupling the steering input device to the adjustment assembly.

According to aspects of the present technology, there is provided a steering assembly for steering a vehicle. The steering assembly includes: a steering input device configured to receive a driver input to steer the vehicle; an adjustment assembly configured to select a driving position of the steering input device from a plurality of driving positions; and a coupling assembly having a coupled configuration and an uncoupled configuration, in the uncoupled configuration, the steering input device being movable from the selected driving position to an ingress-egress position; and in response to moving the coupling assembly from the uncoupled configuration to the coupled configuration, the steering input device being moved from the ingress-egress position to the selected driving position.

For purposes of this application, terms related to spatial orientation such as forwardly, rearward, upwardly, downwardly, left, and right, are as they would normally be understood by a driver of the vehicle sitting thereon in a normal riding position. Terms related to spatial orientation when describing or referring to components or sub-assemblies of the vehicle, separately from the vehicle should be understood as they would be understood when these components or sub-assemblies are mounted to the vehicle, unless specified otherwise in this application.

Embodiments of the present technology each have at least one of the above-mentioned objects and/or aspects, but do not necessarily have all of them. It should be understood that some aspects of the present technology that have resulted from attempting to attain the above-mentioned object may not satisfy these objects and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, rear, left side of an off-road vehicle according to an embodiment of the present technology;

FIG. 2 is a rear elevation view of a steering assembly of the vehicle of FIG. 1;

FIG. 3 is a rear, left perspective view of the steering assembly of FIG. 2;

FIG. 4 is a bottom, left perspective view of the steering assembly of FIG. 1;

FIG. 5 is a bottom, rear, right perspective view of the steering assembly of FIG. 2 with a portion of a steering column and steering rods removed;

FIG. 6 is a close-up, partial, bottom, rear, left perspective view of an adjustment assembly and a coupling assembly of the steering assembly of FIG. 4 with the coupling assembly in a coupled configuration;

FIG. 7 is a close-up, partial, bottom, rear, left perspective view of the adjustment assembly and the coupling assembly of the steering assembly of FIG. 4 with the coupling assembly in an uncoupled configuration;

FIG. 8 is a rear, left perspective view of the steering assembly of FIG. 4 with the coupling assembly in an uncoupled configuration and the steering assembly in an ingress-egress position;

FIG. 9 is a close-up, front view of the steering assembly of FIG. 8;

FIG. 10 is a rear, left rear perspective view of the coupling assembly of FIG. 7; and

FIG. 11 is a flow diagram depicting a method for adjusting a steering wheel of the vehicle of FIG. 1.

It should be noted that the Figures are not necessarily drawn to scale.

### DETAILED DESCRIPTION

The present technology will be described with respect to a four-wheel, off-road vehicle 10 having two side-by-side seats and a steering wheel (i.e., a side-by-side vehicle (SSV)). However, it is contemplated that at least some aspects of the present technology may apply to other types of vehicles such as, but not limited to, off-road vehicles having a single bucket-type seat, off-road vehicles with more than four wheels, off-road vehicles having ground-engaging members other than wheels, and other types of vehicles.

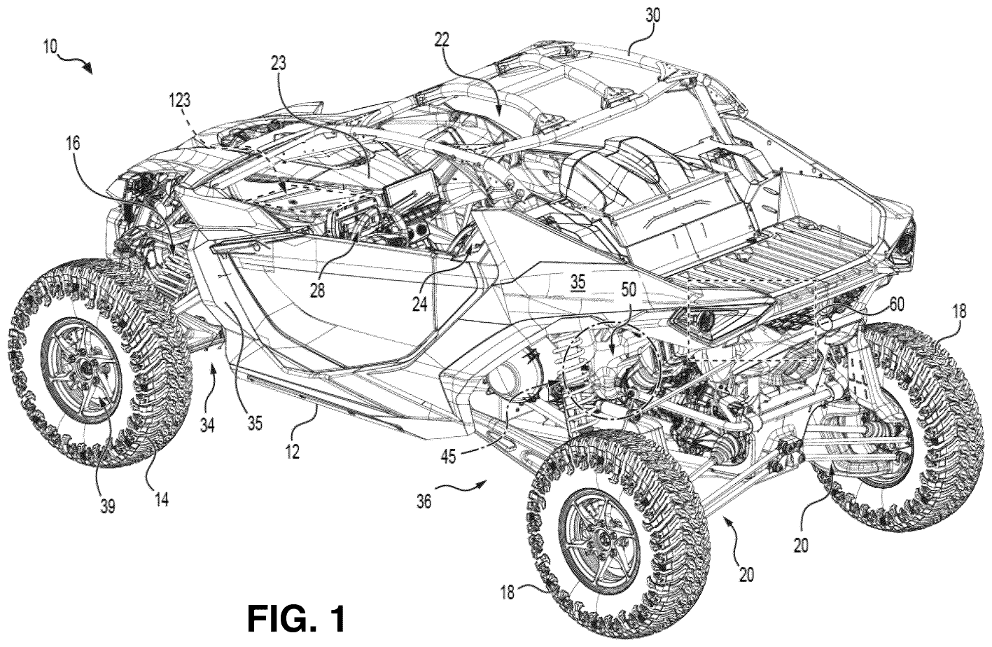

The general features of the off-road vehicle 10 will now be described herein with reference to FIG. 1. The vehicle 10 has a frame 12. The frame 12 defines a central cockpit area 22 inside which are disposed a driver seat 24 and a passenger seat (not shown). The driver seat 24 is disposed on the left side of the vehicle 10 and the passenger seat is disposed on the right side of the vehicle 10. However, it is contemplated that the driver seat 24 could be disposed on the right side of the vehicle 10 and the passenger seat could be disposed on the left side of the vehicle 10. It is also contemplated that the vehicle 10 may include a single seat for the driver, or a larger number of seats, or a bench accommodating the driver and at least one passenger.

The vehicle 10 includes a roll cage 30 connected to the frame 12 and extending at least partially over the driver seat 24 and the passenger seat. The frame 12 has a front area 34 and a rear area 36 disposed forwardly and rearwardly of the central cockpit area 22 respectively. A plurality of body panels 35 are provided on the vehicle 10 to conceal the internal components of the vehicle 10 and to partially enclose the cockpit area 22 of the vehicle 10.

The vehicle 10 includes left and right front wheels 14 connected to the frame 12 by a pair of front suspension assemblies 16. Left and right rear wheels 18 are connected to the frame 12 by a pair of rear suspension assemblies 20. The vehicle 10 has a brake system (not separately shown) including four brake assemblies 39 (two of which are depicted in FIG. 1). Each brake assembly 39 includes a brake disc and a caliper disposed around its corresponding brake disk. Each brake assembly 39 is connected to a respective one of the wheels 14, 18.

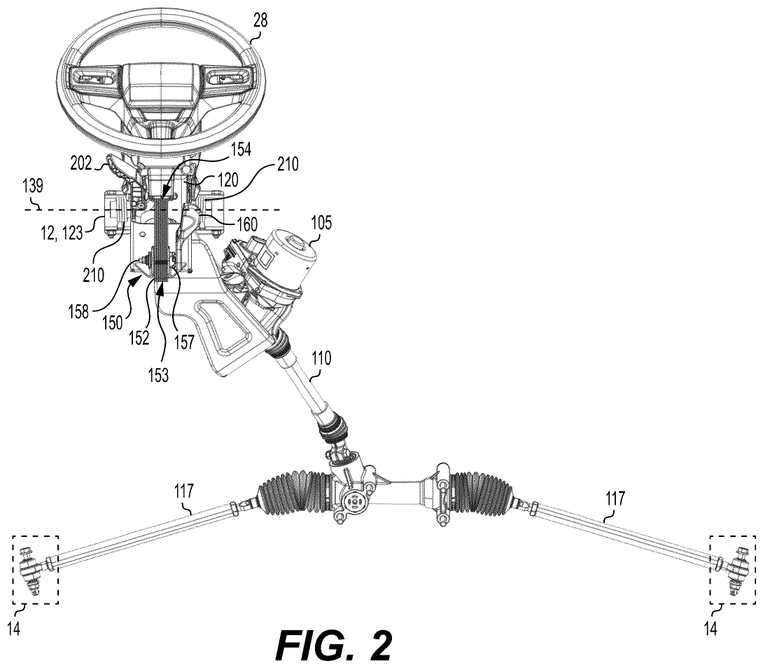

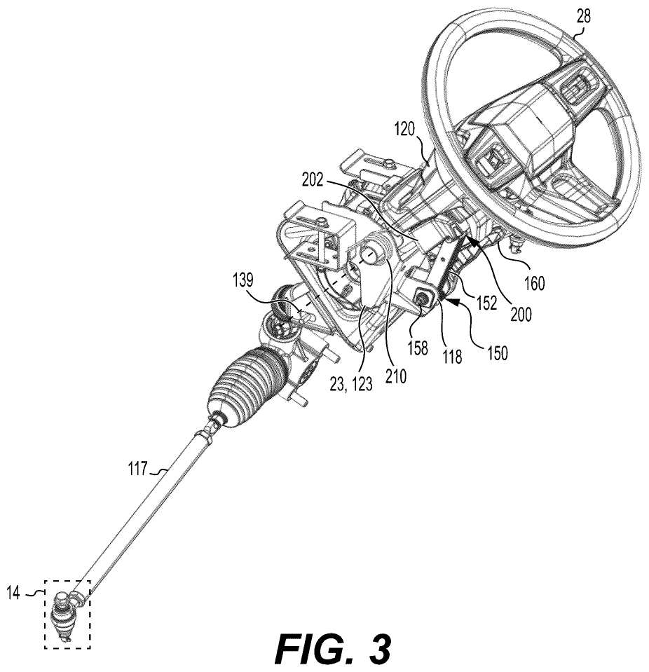

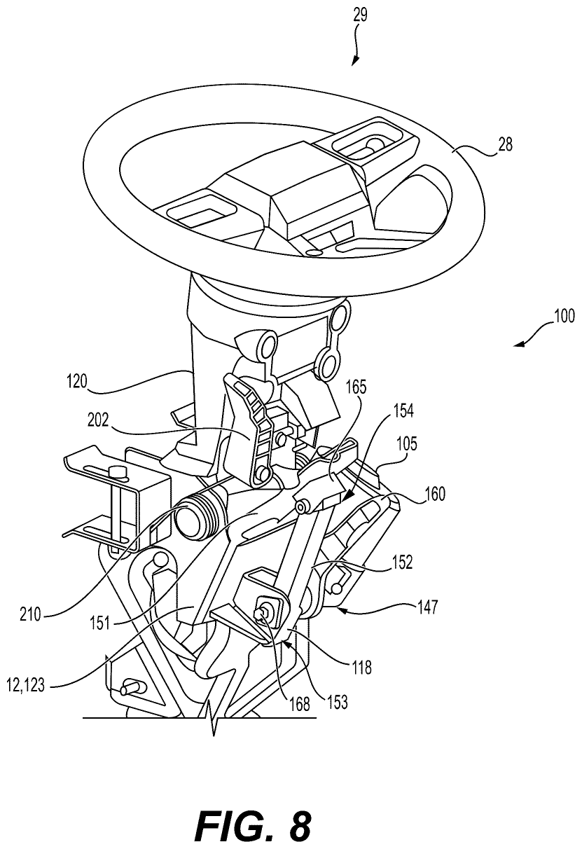

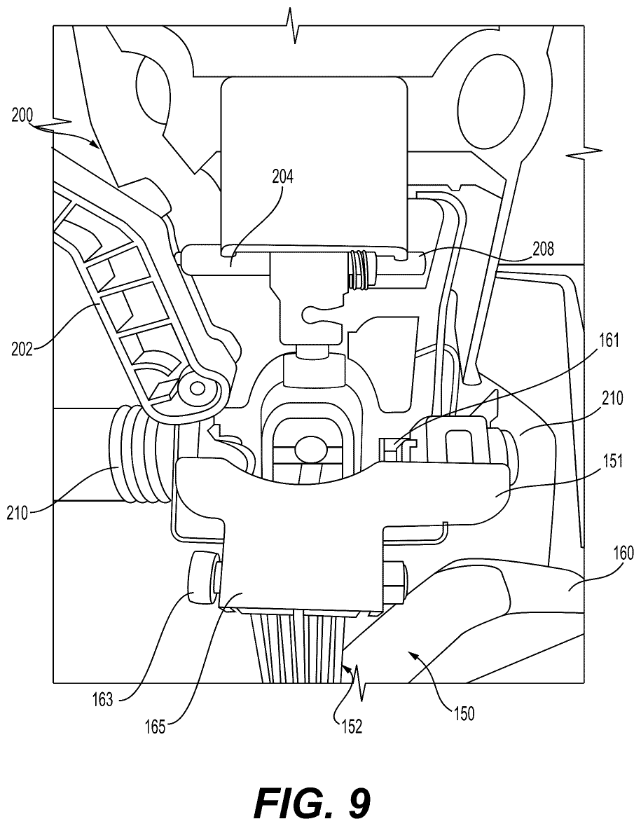

The vehicle 10 has a steering assembly 100 operatively connected to the front wheels 14 for controlling a steering angle of the front wheels 14. The steering system 100 includes a steering input device 29, which includes a steering wheel 28 rotationally connected to a steering support body 120 (depicted in FIGS. 2 to 10), disposed in the cockpit area 22 for a driver of the vehicle 10 to operate from the driver seat 24. The steering wheel 28 is disposed in front of the driver seat 24. The steering assembly 100 is described in further detail below. The vehicle 10 also includes a dashboard 23 disposed forward of the driver seat 24 and the passenger seat. It is contemplated that a steering handlebar or a steering yoke may be implemented instead of the steering wheel 28 of the present embodiment.

The vehicle 10 includes a powertrain 45 (shown schematically in FIG. 1) for driving the wheels 14, 18. The powertrain 45 includes a motor 50 (partially shown in FIG. 1) that is connected to the frame 12 in a rear portion of the vehicle 10. In this embodiment, the motor 50 is an internal combustion engine 50, but it is contemplated that an electric motor or hybrid system could be used in other embodiments. The engine 50 is connected to a continuously variable transmission 60 (shown schematically in FIG. 1) disposed on a right-side of the engine 50.

It is contemplated that the vehicle 10 could include a variety of additional and/or different features excluded from discussion here, including but not limited to: air intake systems, exhaust systems, motor control systems, safety systems, a windscreen, a radio, navigational systems, and/or luggage rack systems.

With references to FIGS. 2 to 7, the steering assembly 100 is illustrated in more detail. In the present embodiment, the steering assembly 100 is a power steering system with a steering motor 105 mounted to the frame 12.

The steering wheel 28 is connected to a steering column 110 of the steering assembly 100 to transmit rotation of the steering wheel 28 to following components of the steering assembly 100. Specifically, the steering wheel 28 is connected to and rotationally fixed relative to an end portion of the steering column 110. The steering assembly 100 further includes two steering rods 117. Each steering rod 117 is operatively connected the steering column 110. The outer end of each steering rod 117 is operatively connected to a corresponding front wheel 14 (illustrated schematically in FIG. 2).

The steering wheel 28 is rotationally connected to the steering support body 120, permitting rotational motion of the steering wheel 28 relative to the steering support body 120. The steering support body 120 is pivotably connected to the frame 12. Specifically, the steering support body 120 is pivotably connected to a dashboard frame portion 123 which forms part of the dashboard 23 of the vehicle 10. The steering support body 120 is pivotable about a laterally extending pivot axis 139, which in turn causes the steering wheel 28 to pivot about the pivot axis 139. Therefore, any reference to the pivoting of the steering wheel 28 about the pivot axis 139 also implies pivoting of the steering support body 120 about the pivot axis 139.

The steering assembly 100 includes an adjustment assembly 150 configured to select a driving position of the steering wheel 28 from multiple driving positions based on the driver's preferred driving settings. That is, the adjustment assembly 150 permits pivoting of the steering wheel 28 about the pivot axis 139 between multiple driving positions to provide adjustability of a driving position of the steering wheel 28 to the driver. In some embodiments, the adjustment assembly 150 provides a range of motion for the steering wheel 28 that spans at least 12° about the pivot axis 139. In other embodiments, the range of motion spans at least 15°. In further alternative embodiments, the range of motion spans at least 18°.

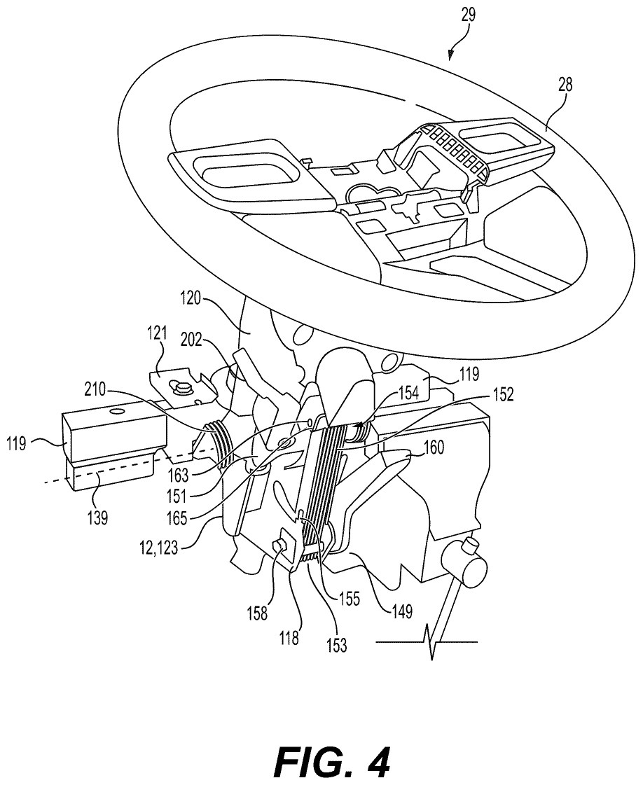

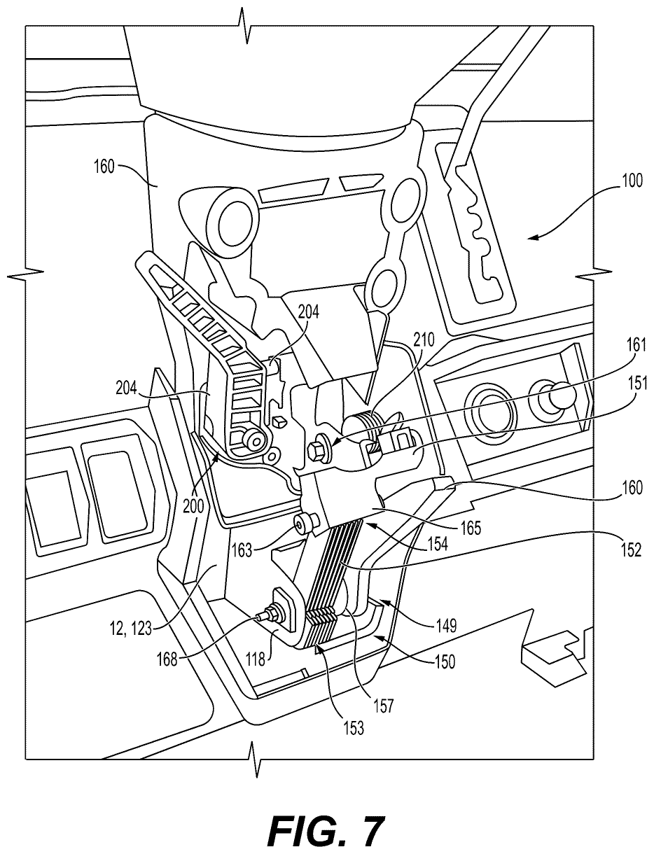

The steering assembly 100 further includes a coupling assembly 200 which allows the steering wheel 28 to be moved between the selected driving position and an ingress-egress position. The ingress-egress position of the steering wheel 28 is configured to facilitate ingressing to and egressing from the vehicle by providing a larger clearance space for the driver of the vehicle 10 to enter and exit. In this embodiment, the ingress-egress position is when the steering wheel 28 is in a frontmost position in the longitudinal direction of the vehicle 10. The ingress-egress position of the steering wheel 28 may be spaced from an uppermost position of the steering wheel 28 by a significant angle or distance. In some embodiments, this angle or distance is at least 10°, or in others at least 20°, or at least 30°, and in some embodiments, even more. Between the ingress-egress position of the steering wheel 28 and the uppermost position of the steering wheel 28, the steering wheel 28 may be freely movable (e.g., rotatable) relative to the vehicle 10. In particular, in this embodiment, the coupling assembly 200 has a coupled configuration (as depicted in FIGS. 4 to 6) and uncoupled configuration (as depicted in FIGS. 7 to 10). In the coupled configuration, actuation of the adjustment assembly 150 causes the steering wheel 28 to become pivotable about the pivot axis 139, to allow the drive to move the steering wheel 28 to a selected driving position. In the uncoupled configuration, the steering wheel 28 is moveable about the pivot axis 139 to allow the driver to move the steering wheel 28 toward a desired one of the selected driving position and the ingress-egress position. More particularly, in the uncoupled configuration, the steering wheel 28 is movable without the driver needing to actuate the adjustment assembly 150. In this embodiment, the coupling assembly 200 is disposed between the adjustment assembly 150 and the steering support body 120. However, it is contemplated that, in alternative embodiments, the adjustment assembly 150 may be disposed between the coupling assembly 200 and the steering support body 120. The coupling assembly 200 is described in further detail below.

With reference to FIGS. 4 to 8, the adjustment assembly 150 will now be described. The adjustment assembly 150 is positioned between the coupling assembly 200 and the frame 12 of the vehicle 10. The adjustment assembly 150 is pivotably connected to the dashboard frame portion 123. The dashboard frame portion 123 is connected to a pair of brackets 121 that are mounted to a frame member 119 of the frame 12. Each bracket 121 is positioned on opposite lateral sides of the dashboard frame portion 123.

The adjustment assembly 150 includes a bracket 151. In the coupled configuration, the bracket 151 is connected to the coupling assembly 200 for coupling the steering support body 120 to the adjustment assembly 150, which is described in further detail below. The bracket 151 is further connected to the dashboard frame portion 123 via fastener 161. The fastener 161 connects the dashboard frame portion 123 at the pivot axis 139. It is contemplated that the bracket 151 may be connected differently in different embodiments.

The adjustment assembly 150 includes a plurality of plates 152 extending between the dashboard frame portion 123 and the bracket 151. While the illustrated embodiment includes seven plates 152, different embodiments could include more or fewer plates 152. The plates 152 are generally identical and arranged adjacent and parallel to one another. In alternative embodiments, the adjustment assembly 150 may instead use a hydraulic cylinder or an electric motor configured to adjust the position of the steering wheel 28.

A rear end portion 154 of each plate 152 is pivotably connected to the bracket 151. Specifically, the rear end portion 154 is connected to an extension 165 formed on a bottom surface of the bracket 151. A fastener 163 extends through an opening (not separately numbered) defined in the extension 165 and an opening (not separately numbered) defined in the rear end portion 154 of the plates 152, thereby allowing the rear end portion 154 of the plates 152 to pivot about the fastener 163.

A forward end portion 153 of each plate 152 is pivotably connected to the dashboard frame portion 123. For each plate 152, a slot 155 is defined in the forward end portion 153. A fastener 158 extends through the slots 155 of the plates 152 to secure the forward end portions 153 to the dashboard frame portion 123. Specifically, the dashboard frame portion 123 forms a bracket 118 for receiving the fastener 158. The fastener 158 is received through the slots 155 of the plates 152. The slots 155 permit movement of the plates 152 when the steering support body 120 is pivoted about the pivot axis 139, relative to the frame 12. It is noted that the configuration of the adjustment assembly 150 may vary in other embodiments. For example, in some embodiments, the bracket 151 of the adjustment assembly 150 may be connected to the forward end portion 153 of the plates 152, while the rear end portion 154 of the plates may have slots 155 to receive the fastener 158. In some embodiments, a length of the adjustment assembly 150 can be extended up to 25 mm (taken from the fastener 168 to the fastener 163). In some embodiments, the length of the adjustment assembly 150 can be extended up to 30 mm. In some embodiments, the length of the adjustment assembly 150 can be extended up to 35 mm.

The adjustment assembly 150 further includes a locking assembly 149 for selectively locking the driving position of the steering wheel 28 relative to the frame 12 of the vehicle 10. The locking assembly 149 has an unlocked configuration and a locked configuration. In the unlocked configuration, the driving position of the steering wheel 28 can be freely adjusted about the pivot axis 139. In the locked configuration, the driving position of the steering wheel 28 is locked.

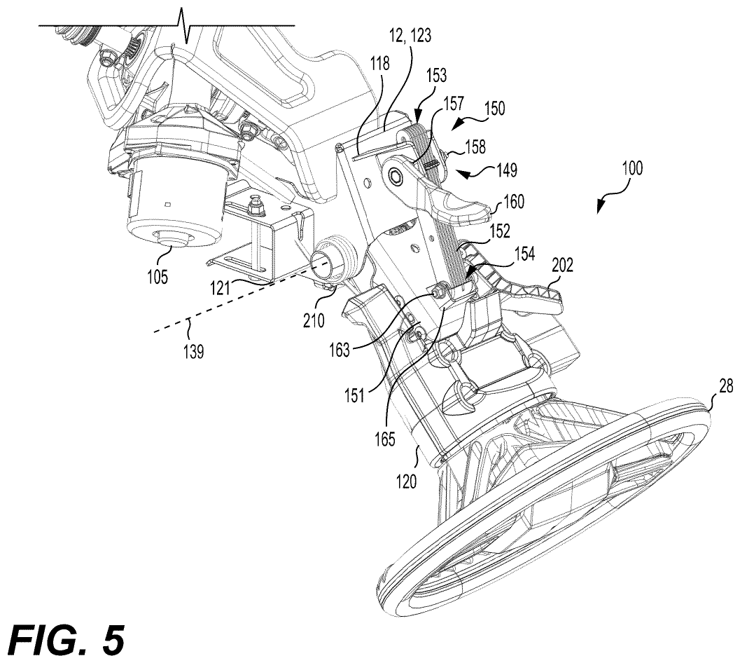

With specific reference to FIG. 5, the locking assembly 149 includes a lever 160 operatively connected to the fastener 158. A cam 157 is operatively connected to and angularly fixed relative to the lever 160. The cam 157 is rotatably connected to the forward end portion 153 of the plates 152. In other words, the fastener 158 connects the lever 160, the cam 157, and the plates 152 together. The lever 160 and the cam 157 are selectively pivotable between an unlocked position, corresponding to the unlocked configuration of the locking assembly 149, and a locked position, corresponding to the locked configuration of the locking assembly 149.

When the lever 160 is in the unlocked position, the plates 152 are permitted to pivot, allowing for pivoting of the steering wheel 28. To move the lever 160 into the locked position, the lever 160 and the cam 157 are rotated. This rotation compresses the plates 152 between the cam 157 and the bracket 118 (more specifically, to one side thereof). Friction between the plates 152 being compressed together, as well as the plates 152 against the cam 157 and the bracket 118 impedes and prevents movement of the plates 152. As a result, the driving position of the steering wheel 28 is locked.

In an alternative embodiment, the adjustment assembly 150 may further includes a telescoping plate for selectively adjusting a distance between the steering wheel 28 and the frame 12. A forward end portion of the telescoping plate is pivotably connected to the frame 12 of the vehicle 10. A rear end portion of the telescoping plate is operatively connected to the cam 157. Similar to the plates 152, the telescoping plate has a slot defined therein and through which extends the fastener 158. When the lever 160 is in the unlocked position, the telescoping plate is selectively translatable, adjusting a length, taken between the forward end portion of the telescoping plate and the rear end portion of the plates, of the adjustment assembly to translate the steering wheel 28 in a forward or rearward direction.

In some embodiments, the adjustment assembly 150 may further include a biasing mechanism to bias the steering wheel 28 to a default position when the locking assembly 149 is in the unlocked configuration. For example, to prevent the steering wheel 28 from pivoting downwards under the force of gravity, the biasing mechanism may bias the steering wheel 28 to a raised default position.

In alternative embodiments, a different adjustment assembly 150 may be implemented, including but not limited to a hydraulic cylinder, a sliding post with holes and insertable pins, a ratcheting mechanism, a telescoping tube and locking mechanism, etc.

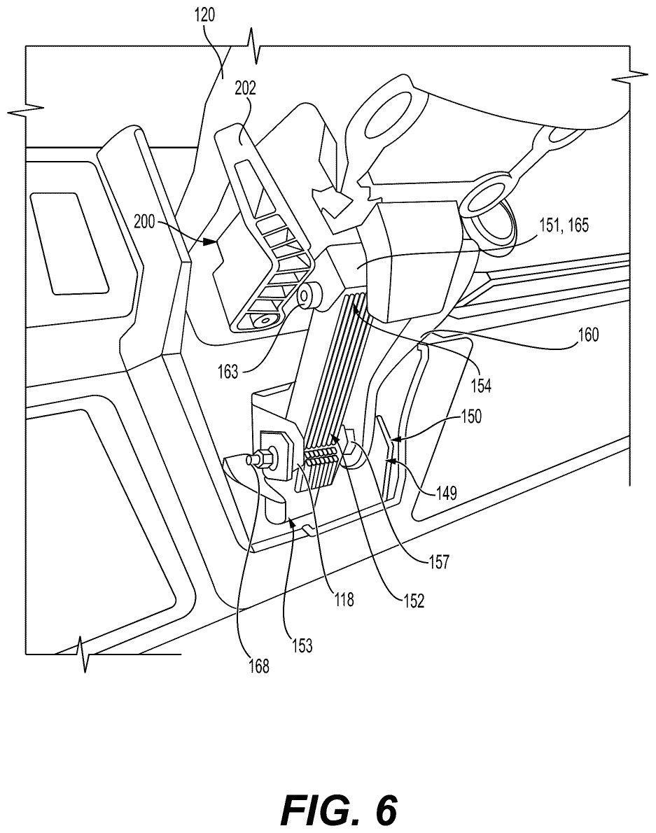

With reference to FIGS. 6 to 10, the coupling assembly 200 will now be described in further detail. As mentioned above, in this embodiment, the coupling assembly 200 is disposed between the steering support body 120 and the adjustment assembly 150.

When the coupling assembly 200 is in the coupled configuration, the steering support body 120, and consequently the steering wheel 28, is coupled to the adjustment assembly 150. As a result, actuation of the adjustment assembly 150 causes the steering wheel 28 to pivot about the pivot axis 139 between multiple driving positions, allowing the driver to adjust the driving position of the steering wheel 28 to their preferred driving settings.

When the coupling assembly 200 is in the uncoupled configuration, the steering support body 120 is uncoupled from the adjustment assembly 150. As a result, the steering wheel 28 is moveable independently from the adjustment assembly 150. This allows the driver to move the steering wheel 28 to the ingress-egress position without altering a state of the adjustment assembly 150, such that the adjustment assembly 150 retains the driving position of the steering wheel 28. In this embodiment, when moving from the driving position to the ingress-egress position, the steering wheel 28 is raised towards the dashboard 23 of the vehicle 10. Specifically, the steering wheel 28 is pushed upwards and away from the adjustment assembly 150. This movement positions the steering wheel 28 into a less obstructive position within the cockpit area 22 to facilitate entry into and exit from the vehicle 10. When uncoupled, the steering wheel 28 has a greater range of motion than that provided when coupled to the adjustment assembly 150. In other words, a range of motion of the steering wheel 28 when the steering support body 120 is uncoupled from the adjustment assembly 150 is greater than a range of motion of the steering wheel 28 when the steering support body 120 is coupled to the adjustment assembly 150.

It is contemplated that, in alternative embodiments, the adjustment assembly 150 may be disposed in between the coupling assembly 200 and the steering support body 120. In this instance, the adjustment assembly 150 and the steering wheel 28 would move to the ingress-egress position together. Movement of the steering wheel 28 to the ingress-egress position would not require adjustment of the adjustment assembly 150 and therefore the state of the adjustment assembly 150 would be maintained.

In this embodiment, the coupling assembly 200 is connected to the steering support body 120. The coupling system 200 includes an actuator, which in the present embodiment is a lever 202, operatively connected to a pin 204. The lever 202 and the pin 204 are positioned on a bottom portion of the steering support body 120. The lever 202 moves the pin 204 between an extended position and a retracted position. In this embodiment, the pin 204 moves along a direction parallel to the pivot axis 139. In alternative embodiments, the lever 202 may be replaced with a different actuator, such as a knob, an electric actuator, a hydraulic actuator, or any other suitable actuator. In further alternative embodiments, the lever 202 may be omitted, for example the driver may manually insert and remove the pin 204.

In the extended position, the pin 204 extends laterally outward and is receivable by an aperture 206 defined in the bracket 151 of the adjustment assembly 150. When the pin 204 is slidably received in the aperture 206, the coupling assembly 200 is in the coupled configuration, coupling the steering support body 120 to the adjustment assembly 150.

In the retracted position, the pin 204 is retracted laterally inward and is withdrawn from the aperture 206, uncoupling the steering support body 120 from the adjustment assembly 150. This moves the coupling assembly 200 into the uncoupled configuration.

In this embodiment, the pin 204 is spring-loaded to bias the pin 204 towards the extended position. Actuation of the lever 202 causes the pin 204 to move from the extended position to the retracted position. It is contemplated that, in other embodiments, the pin 204 may not be spring-loaded and movement of the lever 202 causes corresponding movement of the pin 204, for example inward movement of the lever 202 moves the pin 204 into the extended position and outward movement of the lever 202 moves the pin 204 into the retracted position.

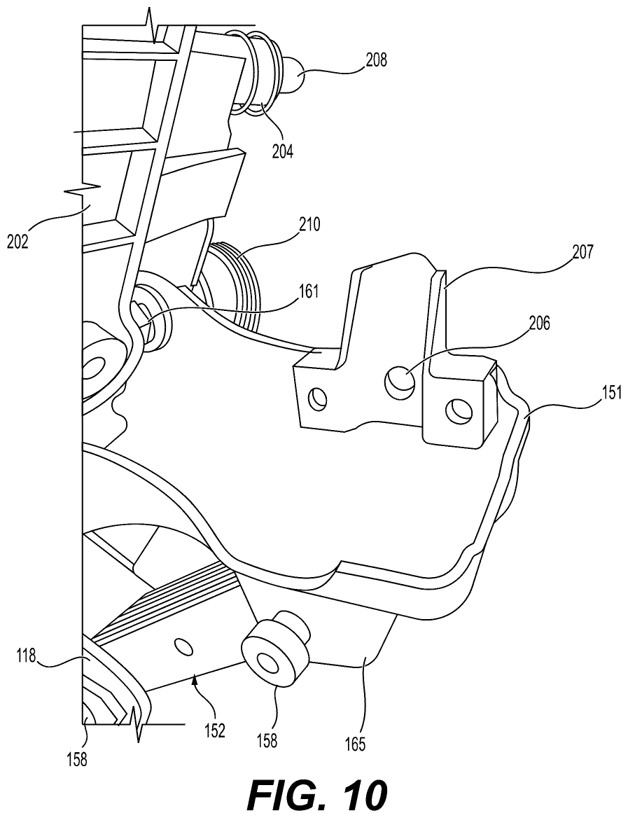

A tip 208 of the pin 204 which is received by the aperture 206 is a rounded tip 208. The rounded tip 208 provides improved durability of the tip 208 of the pin 204 and facilitates alignment, guiding the tip 208 of the pin 204 into the aperture 206 more easily. Additionally, the rounded tip 208 reduces wear and tear experienced by both the pin 204, as well as the bracket 151 during insertion and removal, leading to longer component life. It is noted that the tip 208 of the pin 204 may vary in other embodiments. As depicted in FIG. 10, the bracket 151 has a guide 207 that defines the aperture 206 to further facilitate alignment of the pin 204 and the aperture 206. The guide 207 defines a channel configured to receive the rounded tip 208 of the pin 204. Specifically, as the driver pivots the steering wheel 28 towards the adjustment assembly 150, the rounded tip 208 of the pin 204 engages with the channel of the guide 207. As the steering wheel 28 continues to move downwards, the pin 204 is guided by the channel until the pin 204 is aligned with the aperture 206. Once aligned, the spring pushes the pin 204 into the extended position, inserting the pin 204 into the aperture 206. The spring-loaded pin 204 makes the coupling process automatic, requiring no actuation of the lever 202 by the driver. It is contemplated that the guide 207 may be omitted in some embodiments.

It is contemplated that, in alternative embodiments, the coupling assembly 200 may be configured differently. In some embodiments, the guide 207 may be positioned on the steering support body 120 with the pin 204 and lever 202 being connected to the bracket 151 of the adjustment assembly 150. In further alternative embodiments, the pin 204 may be fixed on the steering support body 120 while the guide 207 is operatively connected to the lever 202, allowing the guide 207 to move and engage with the fixed pin 204. In an even further alternative embodiment, the coupling assembly 200 may be a latch having a fixed pin 204 and a spring-loaded catch configured to open and engage the pin 204 when pushed against it.

The steering assembly 100 further includes two biasing members 210, which in the present embodiment are torsion springs 210, to bias the steering wheel 28 towards the ingress-egress position when the coupling assembly 200 is in the uncoupled configuration. Although two springs 210 are used, it is contemplated that any number of springs 210 may be used. The springs 210 are identical, with each spring 210 being disposed on a lateral side of the steering support body 120. The springs 210 arc positioned about the pivot axis 139 with one end connected to the frame 12 of the vehicle 10 and the other end connected to the steering support body 120. In alternative embodiments, the springs 210 may be replaced with other biasing mechanisms such as a hydraulic or pneumatic cylinder. In further alternative embodiments, the biasing members 210 may be omitted.

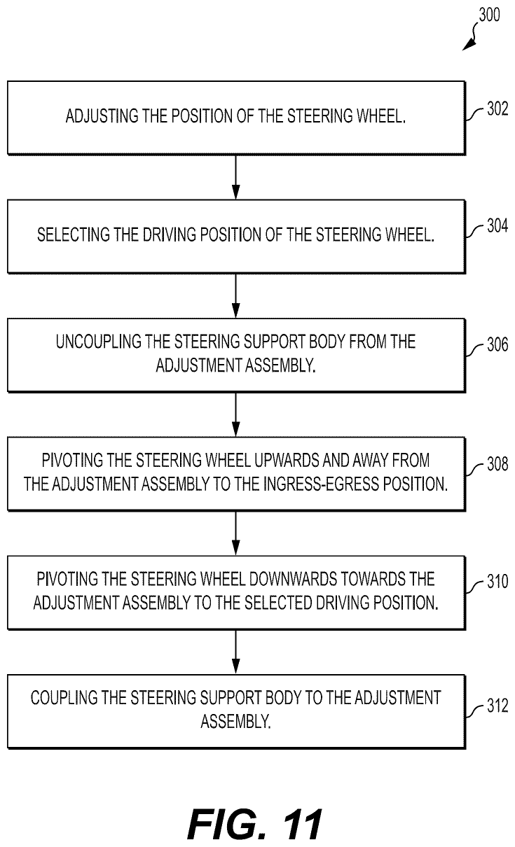

With reference to FIG. 11, a method 300 of adjusting the position of the steering wheel 28 of the steering assembly 100 will now be described.

As described previously. when the coupling assembly 200 is in the coupled configuration and the locking assembly 149 is in the unlocked configuration, the steering wheel 28 is pivotable about the pivot axis 139. As such, the method 300 begins, at step 302, with adjusting the position of the steering wheel 28 about the pivot axis 139 between multiple driving positions. Specifically, with the lever 160 of the locking assembly 149 in the unlocked position, the plates 152 can are moveable enabling the steering wheel 28 to pivot. In some instances, in embodiments with the telescoping plate, step 302 may further include translating the steering wheel in the forward and rearward directions via the telescoping plate. When the driver is satisfied with the position of the steering wheel 28, the method 300 continues, at step 304, with selecting the driving position of the steering wheel 28. Specifically, at step 304, the driver turns the lever 160 of the locking assembly 149 to the locked position, thereby impeding movement of the plates 152 to lock the steering wheel 28.

When the driver is ready to exit the vehicle 10, the method 300 continues, at step 306, with moving the coupling assembly 200 into the uncoupled configuration, thereby uncoupling the steering support body 120 from the adjustment assembly 150. At step 306, the driver actuates the lever 202 of the coupling assembly 200 to move the pin 204 to the retracted position. The pin 204 is withdrawn from the aperture 206 of the bracket 151 of the adjustment assembly 150.

With the steering support body 120 now uncoupled from the adjustment assembly 150, the method 300 continues, at step 308, with pivoting the steering wheel 28 upwards and away from the adjustment assembly 150 to the ingress-egress position. The driver may now comfortably exit the vehicle 10 without having to adjust the state of the adjustment assembly 150.

At step 310, when the driver enters the vehicle 10 with the steering wheel 28 in the ingress-egress position, the driver simply needs to pivot the steering wheel 28 downwards towards the adjustment assembly 150. The method 300 continues, at step 312, coupling the steering support body 120 to the adjustment assembly 150. Since the pin 204 (being spring-loaded) is biased towards the extended position, as the steering wheel 28 is lowered, the pin 204 is slidably received by the aperture 206 in the bracket 151 of the adjustment assembly 150. This moves the coupling assembly 200 into the coupled configuration, thereby coupling the steering support body 120 to the adjustment assembly 150. Since the state of the adjustment assembly 150 was not altered during movement of the steering wheel 28 to the ingress-egress position, the driving position of the steering wheel 28 does not need to be re-adjusted via the adjustment assembly 150.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A steering assembly for steering a vehicle, the steering assembly comprising:
a steering input device configured to steer the vehicle and to pivotably connect to a frame of the vehicle to pivot about a laterally extending pivot axis,
an adjustment assembly configured to select a driving position of the steering input device from a plurality of driving positions;
a coupling assembly having:
a coupled configuration, in which, upon actuation of the adjustment assembly, the steering input device is moveable about the pivot axis between the plurality of driving positions; and
an uncoupled configuration, in which, without actuation of the adjustment assembly, the steering input device is moveable about the pivot axis to an ingress-egress position; and
one of the adjustment assembly and the coupling assembly being disposed between the steering input device and an other one of the adjustment assembly and the coupling assembly.

2. The steering assembly of claim 1, wherein the coupling assembly is disposed between the steering input device and the adjustment assembly.

3. The steering assembly of claim 2, further comprising:
a dashboard frame portion connected to the adjustment assembly and adapted to connect to the frame of the vehicle; and
wherein the steering input device is pivotably connected to the dashboard frame portion.

4. The steering assembly of claim 2, wherein, in the uncoupled configuration, the adjustment assembly is uncoupled from the steering input device such that the steering input device is movable independently from the adjustment assembly.

5. The steering assembly of claim 2, wherein, in the coupled configuration, the adjustment assembly is connected to the steering input device.

6. The steering assembly of claim 2, wherein:
the adjustment assembly defines an aperture; and
the coupling assembly is connected to the steering input device, the coupling assembly comprises:
an actuator; and
a pin operatively connected to the actuator, the pin being moveable between:
an extended position, in which the pin is slidably received in the aperture, thereby coupling the steering input device and the adjustment assembly in the coupled configuration, and
a retracted position, in which the steering input device and the adjustment assembly are in the uncoupled configuration.

7. The steering assembly of claim 6, wherein the pin comprises a rounded tip which is slidably receivable in the aperture.

8. The steering assembly of claim 6, wherein the pin is spring-loaded to bias the pin towards the extended position.

9. The steering assembly of claim 6, wherein, upon actuation of the actuator, the pin moves from the extended position to the retracted position.

10. The steering assembly of claim 6, wherein the pin moves in a direction parallel to the pivot axis.

11. The steering assembly of claim 6, wherein the actuator comprises a lever.

12. The steering assembly of claim 1, wherein:
the adjustment assembly comprises a locking mechanism configured to selectively lock a state of the adjustment assembly, thereby locking the selected driving position of the steering input device.

13. The steering assembly of claim 12, wherein in the uncoupled configuration, the locking assembly retains the state of the adjustment assembly.

14. The steering assembly of claim 1, wherein the adjustment assembly is disposed below the steering input device.

15. The steering assembly of claim 1, further comprising at least one biasing member configured to bias the steering input device upwards when the steering input device and the adjustment assembly are in the uncoupled configuration.

16. The steering assembly of claim 15, wherein:
the at least one biasing member is a spring disposed about the pivot axis, the spring having:
a first end connected to the steering input device, and
a second end configured to connect to the frame of the vehicle.

17. The steering assembly of claim 1, wherein:
in the coupled configuration, the steering input device is pivotable within a coupled range of motion; and
in the uncoupled configuration, the steering input device is pivotable within an uncoupled range of motion, the uncoupled range of motion being larger than the coupled range of motion.

18. A vehicle comprising:
a frame;
a plurality of ground-engaging members operatively connected to the frame;
a motor supported by the frame for driving the vehicle; and
a steering assembly having:
a steering input device for steering the vehicle, the steering input device pivotably connected to the frame to pivot about a laterally extending pivot axis;
an adjustment assembly configured to select a driving position of the steering input device from a plurality of driving positions;
a coupling assembly having:
a coupled configuration, in which, upon actuation of the adjustment assembly, the steering input device is moveable about the pivot axis between the plurality of driving positions; and
an uncoupled configuration, in which, without actuation of the adjustment assembly, the steering input device is moveable about the pivot axis to an ingress-egress position; and
one of the adjustment assembly and the coupling assembly being disposed between the steering input device and an other one of the adjustment assembly and the coupling assembly.

19. The vehicle of claim 18, wherein the vehicle is a side-by-side vehicle.

20. A steering assembly for steering a vehicle, the steering assembly comprising:
a steering input device configured to receive a driver input to steer the vehicle;
an adjustment assembly configured to select a driving position of the steering input device from a plurality of driving positions; and
a coupling assembly having a coupled configuration and an uncoupled configuration,
in the uncoupled configuration, the steering input device being movable from the selected driving position to an ingress-egress position; and
in response to moving the coupling assembly from the uncoupled configuration to the coupled configuration, the steering input device being moved from the ingress-egress position to the selected driving position.
